(19) United States
(12) Patent Application Publication
(10) Pub. No.: US 2003/0021179 A1
(43) Pub. Date: Jan. 30, 2003

(54) Manual mixing apparatus

(76) Inventors: Matthew G. Goulet, Milwaukee, WI (US); Benjamin C. Johansen, Cedarburg, WI (US); Todd R. Niemuth, Oostburg, WI (US); Jay Z. Muchin, Manitowoc, WI (US); David J. Merten, Manitowoc, WI (US); Darryl L. Kaminski, Greendale, WI (US); Scott M. Wesbrook, New Berlin, WI (US); Brian E. Woodnorth, Whitefish Bay, WI (US); Craig S. Serio, New Berlin, WI (US); Christina L. Fortner, Oak Creek, WI (US); Dana W. Altheimer, Port Washington, WI (US); Ronald C. Farnum, Glen Ellyn, IL (US); Peter M. Schmidt, Chicago, IL (US)

Correspondence Address: Marshall, Gerstein & Borun, 6300 Sears Tower, 233 S. Wacker Drive, Chicago, IL, 60606-6357, US

(21) Appl. No.: 10/154,877

(22) Filed: May 24, 2002

Related U.S. Application Data
(60) Provisional application No. 60/308,321, filed on Jul. 25, 2001.

(51) Int. Cl. B01F 13/00

(52) U.S. Cl. 366/129

(57) ABSTRACT

A manual mixing apparatus includes an elongate member extending along a longitudinal axis from a first end to a second end. The elongate member includes a first surface and a second surface separated by an opening or a flow passage therebetween. In one embodiment, the first surface and the second surface are concave so as to direct fluid towards the opening or flow passage. In one embodiment, the apparatus includes a flow separating structure located in relationship to a flow passage such that fluid flowing through the flow passage is divided. In yet another embodiment, the apparatus includes a paddle portion and a conical surface coupled to the paddle portion.

### CROSS-REFERENCE TO RELATED PATENT APPLICATIONS

The present application claims priority under 35 U.S.C. § 119(e) from U.S. Provisional Patent Application Serial No. 60/308,321 entitled PAINT ACCESSORIES INCLUDING ERGONOMIC PAINT TRAY, PAINT ROLLER, PAINT BUCKET TROLLEY, MOVEABLE PAINT ROLLER LOADING CONTAINER, MANUALLY POWERED PAINT MIXER STICK AND ERGONOMIC PAINT BRUSHES and filed on Jul. 25, 2001 by Niemuth et al., the full disclosure of which, in its entirety, is hereby incorporated by reference.

### BACKGROUND OF THE INVENTION

Paint is typically sold in cans, buckets or other containers. Over time, the materials forming the paint tend to separate resulting in thicker sediment resting on the bottom of the container or along the sides of the container and the thinner paint liquid along the top of the paint in the container. As a result, paint must be mixed prior to being applied. For purposes of this application, the term “paint” shall mean any liquid coating composed of different materials or elements that separate and must later be mixed before application. “Paint” shall include, but is not limited to, stains, sealants, varnishes, conventional oil-based paints and latex-based paints.

Mixing of paint at the site where the paint is to be applied is typically achieved by using either a powered paint mixer or a conventionally known wooden stick. Powered mixers typically include a drive unit substantially similar to a drill and a paint mixer attachment which mounts to a drive unit like a drill bit and which includes blades which mix the paint upon the attachment being rotatably driven by the drive unit. Due to the size and expense of such powered mixers, the use is largely limited to professional painters.

In contrast, do-it-yourself painters typically utilize a conventionally known paint stick. Such paint sticks generally comprise elongate strips of wood having a length of about one foot. Such wooden paint sticks are frequently given away at the store selling the paint. The store selling the paint typically provides one wooden stick per can.

Although free, such wooden paint sticks have several drawbacks. First, the use of such sticks is messy. As noted above, such sticks are typically around one foot in length. As a result of this short length, paint frequently becomes deposited upon the hand holding the stick during mixing. Moreover, because such sticks are generally flat, such sticks create a large amount of surface turbulence when a full can of paint is being stirred. This turbulence creates a paint wave that frequently contacts the user's hands when mixing. The wave also flows into a groove on the top of the can or paint container, if not over the side of the paint container itself. Thus, mixing paint with a conventionally known paint stick frequently results in a mess of paint covering a person's hands, the top groove of the paint can and the sides of the paint can.

Second, such wooden paint sticks are difficult and messy to clean up or even discard. Because the paint soaks into the wood, paint sticks cannot be easily wiped clean after use. Moreover, because the paint stick is typically flat, the paint stick cannot be simply wiped against the edge of the can which is round. As a result, such wet paint sticks are frequently laid on a newspaper or just left in the can until the painting job is completed. Washing the wooden paint stick presents further problems since a paint stick must be transferred to a sink or faucet without dripping. Because the stick is formed from wood, cleaning the stick under a stream of water often results in splinters. Because the paint soaks into the wood, the wood stick is never completely free of the paint, resulting in the stick physically sticking to the newspaper upon which the stick is drying. Despite the most valiant clean up efforts, the wood is still susceptible to splintering and warpage due to liquid retention by the wood.

Third, mixing paint with such conventional wooden sticks is tiresome and ineffective. Because such conventional paint sticks simply comprise generally flat linear slabs or strips of wood, such paint sticks are uncomfortable to hold and are generally shaped to encourage unnatural and fatiguing hand and wrist posture. Because such paint sticks are generally flat and solid slabs of wood, paint being mixed resists stirring, making it harder to stir the paint. Moreover, conventional painting sticks cannot reach the corners and sides of the can or paint container where the separated paint sediment commonly collects. As a result, the paint is not completely mixed, inhibiting one-coat coverage of the paint.

Thus, there is a continuing need for an inexpensive manually powered device (1) that effectively mixes paint, (2) that is less messy to use, (3) that is easy to clean, and (4) that is less fatiguing to hold and use when mixing the paint.

### SUMMARY OF THE INVENTION

According to one exemplary embodiment of the present invention, a manual mixing apparatus for use with a paint container having an interior floor, a rim having a width and an interior height between the floor and the rim includes an elongate member extending along a longitudinal axis from a first end to a second end. The elongate member includes a first paddle portion proximate the first end. The first paddle portion includes a first face, a second face, a first edge and a second edge, and at least one opening between the first edge and the second edge. The first face is concave so as to direct fluid towards the at least one opening.

According to yet another exemplary embodiment of the present invention, a manual mixing apparatus comprises an elongate member and a flow separating structure. The elongate member extends along a longitudinal axis from a first end to a second end and includes a first surface and a second surface separated from a flow passage therebetween. The flow separating structure is located in relationship to the flow passage such that the fluid flowing through the flow passage is divided by the flow separation structure.

According to yet another exemplary embodiment of the present invention, a manual paint mixing apparatus includes an elongate member extending along a longitudinal axis from a first end to a second end. The member includes a first paddle portion proximate the first end and a conical surface coupled to the first paddle portion at the first end.

According to yet another exemplary embodiment of the present invention, a manual paint mixing apparatus includes an elongate member extending along a longitudinal axis from a first end to a second end. The member includes a paddle portion proximate the first end and including a first face, a second face, a first edge, a second edge, and at least one opening between the first edge and the second edge. The first edge and the second edge taper towards the first end.

According to yet another exemplary embodiment, a manual paint mixing apparatus includes an elongate member extending along a longitudinal axis from a first end to a second end. The member includes a paddle portion proximate the first end. The paddle portion includes a first face, a second face, a first edge, a second edge, and at least one opening between the first edge and the second edge. At least one of the first end, the first edge, and the second edge includes an elastomeric wiping surface.

According to yet another exemplary embodiment, a manual paint mixing apparatus includes an elongate member extending along a longitudinal axis from a first end to a second end. The member includes a handle portion and a paddle portion coupled to the handle portion. The paddle portion includes a first edge, a second edge, and at least one opening between the first edge and the second edge. The paddle portion moves between a retracted position in which the paddle portion and at least a part of the paddle portion are overlapping and an extended position.

According to yet another exemplary embodiment, a manual paint mixing apparatus includes an elongate member extending along a longitudinal axis from a first end to a second end. The member includes a first paddle portion proximate the first end and a second paddle portion proximate the second end. The first paddle portion includes a first edge, a second edge and at least one first opening between the first edge, and the second edge. The second paddle portion includes a third edge, a fourth edge, and at least one second opening between the third edge and the fourth edge.

According to yet another exemplary embodiment, a manual paint mixing apparatus includes an elongate member extending along a longitudinal axis from a first end to a second end. The member includes a handle portion and a paddle portion rotatably coupled to the handle portion. The paddle portion at least partially rotates relative to the handle portion during mixing of paint.

### BRIEF DESCRIPTION OF THE DRAWINGS

FIG. 1 is a top perspective view of an exemplary embodiment of a manual paint mixer of the present invention.

FIG. 2 is a bottom perspective view of the mixer of FIG. 1.

FIG. 3 is a top plan view of the mixer of FIG. 1.

FIG. 4 is a rear elevational view of the mixer of FIG. 1, the front elevational view being a mirror image thereof.

FIG. 5 is a bottom plan view of the mixer of FIG. 1.

FIG. 6 is a right end elevational view of the mixer of FIG. 1.

FIG. 6A is a left end elevational view of the mixer of FIG. 1.

FIG. 6B is a sectional view of the mixer of FIG. 3 taken along lines 6B-6B.

FIG. 7 is a top elevational view of the mixer of FIG. 1 illustrating the mixer in a paint container.

FIG. 7A is an enlarged fragmentary view of the mixer of FIG. 7 taken along line 7A-7A.

FIG. 7B is an enlarged fragmentary view of the mixer of FIG. 7 taken along line 7B-7B.

FIG. 8 is a fragmentary top plan view of a first alternative embodiment of the mixer of FIG. 1.

FIG. 9 is a top plan view of a second alternative embodiment of the mixer of FIG. 1 illustrating a paddle portion in an extended position.

FIG. 9A is a sectional view of the mixer of FIG. 9 taken along line 9A-9A illustrating the paddle portion in a retracted position.

FIG. 10 is a top plan view of a third alternative embodiment of the mixer of FIG. 1.

FIG. 11 is a top plan view of a fourth alternative embodiment of the mixer of FIG. 1.

FIG. 12 is a top plan view of a fifth alternative embodiment of the mixer of FIG. 1.

FIG. 12A is an enlarged fragmentary view of the mixer of FIG. 12 taken along line 12A-12A illustrating the mixer engaging a rim of a paint can.

FIG. 13 is a top plan view of a sixth alternative embodiment of the mixer of FIG. 1.

FIG. 14 is a top plan view of a seventh alternative embodiment of the mixer of FIG. 1.

FIG. 15 is a left end elevational view of the mixer of FIG. 14.

FIG. 16 is a top perspective view of an eighth alternative embodiment of the mixer of FIG. 1.

FIG. 17 is a top plan view of the mixer of FIG. 16.

FIG. 18 is a bottom plan view of the mixer of FIG. 16.

FIG. 19 is a front elevational view of the mixer of FIG. 16.

FIG. 20 is a rear elevational view of the mixer of FIG. 16.

FIG. 21 is a right end elevational view of the mixer of FIG. 16.

FIG. 22 is a left end elevational view of the mixer of FIG. 16.

FIG. 23 is a top plan view of a ninth alternative embodiment of the mixer of FIG. 1.

FIG. 24 is a bottom plan view of the mixer of FIG. 23.

FIG. 25 is a left end elevational view of the mixer of FIG. 23.

FIG. 25A is a sectional view of the mixer of FIG. 23 taken along line 25A-25A.

FIG. 26 is a top plan view of a tenth alternative embodiment of the mixer of FIG. 1.

FIG. 27 is a bottom plan view of the mixer of FIG. 26.

FIG. 28 is a left end elevational view of the mixer of FIG. 26.

FIG. 29 is a top plan view of an eleventh alternative embodiment of the mixer of FIG. 1.

FIG. 30 is a left end elevational view of the mixer of FIG. 29.

FIG. 31 is a top perspective view of a twelfth alternative embodiment of the mixer of FIG. 1.

FIG. 32 is a top plan view of the mixer of FIG. 31.

FIG. 33 is a bottom plan view of the mixer of FIG. 31.

FIG. 34 is a front elevational view of the mixer of FIG. 31.

FIG. 35 is a rear elevational view of the mixer of FIG. 31.

FIG. 36 is a left end elevational view of the mixer of FIG. 31.

### DETAILED DESCRIPTION OF THE PREFERRED EMBODIMENTS

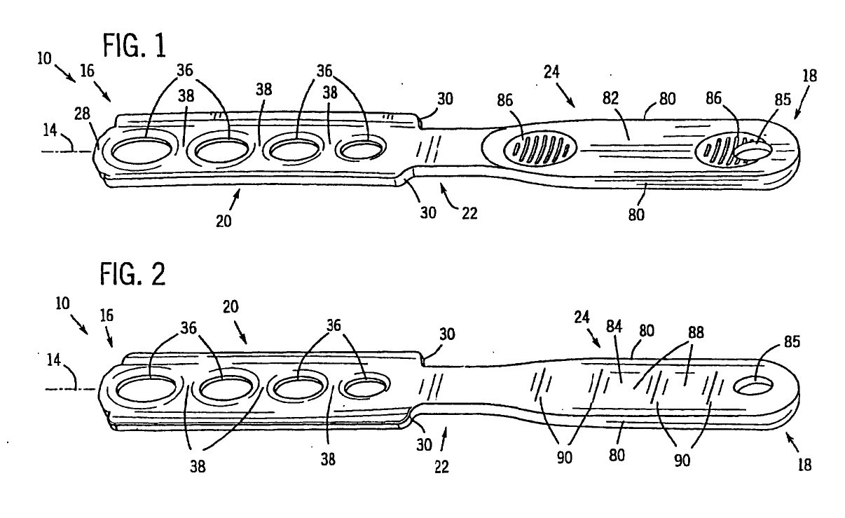

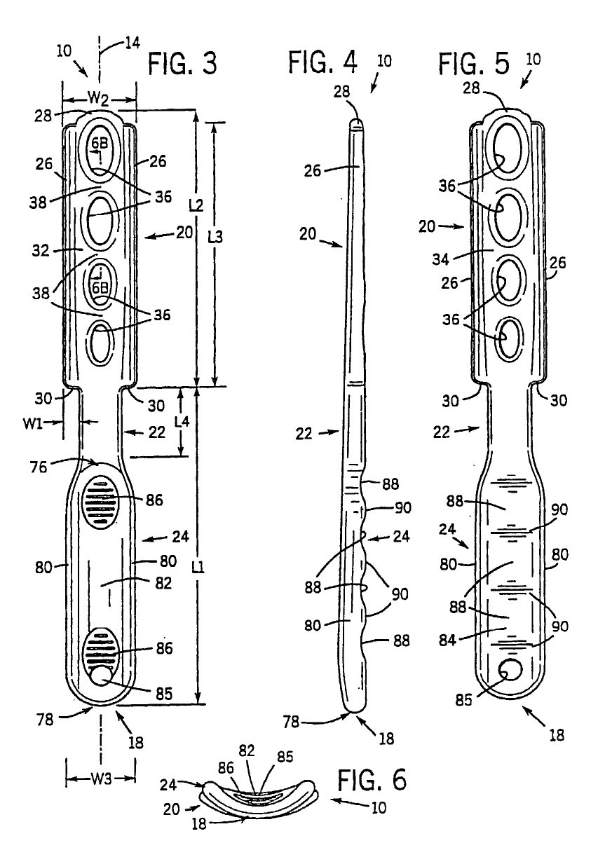

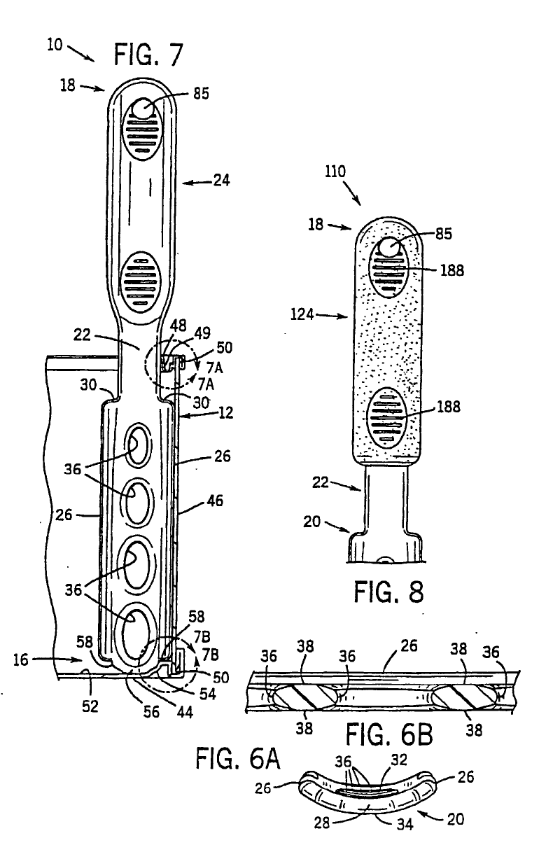

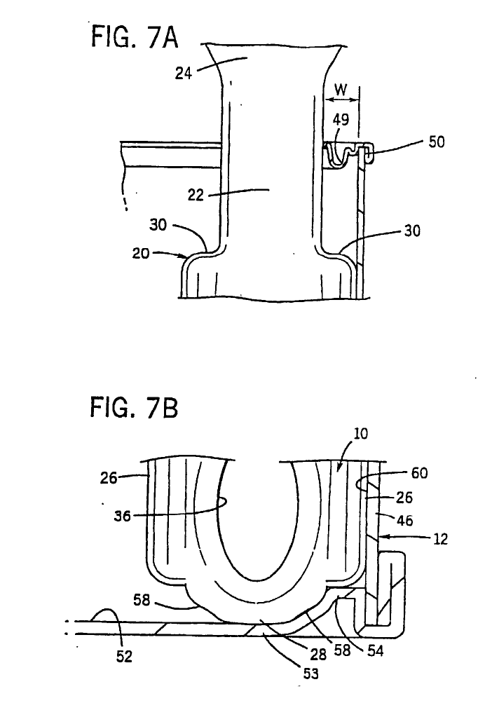

FIGS. 1-6 illustrate manual paint mixer 10. FIGS. 7, 7A and 7B illustrate mixer 10 positioned within a conventionally known paint container 12 (shown as a paint can). Manual paint mixer 10 is generally an elongate member extending along a longitudinal axis 14 from a first end 16 to a second end 18. Mixer 10 is generally an elongate stick configured for being manually manipulated to mix paint in a paint container or paint can. Mixer 10 generally includes paddle portion 20, neck portion 22, and handle portion 24. Paddle portion 20 is an elongate portion of mixer 10 configured to be submersed within the paint and to stir or mix the paint as a result of movement of mixer 10. Paddle portion 20 includes transverse edges 26, tip 28, shoulders 30 and opposing faces 32 (shown in FIG. 3), 34 (shown in FIG. 5). Edges 26 extend on opposite transverse sides of paddle portion 20 between faces 32, 34. Edges 26 serve as rigid spines of paddle portion 20. Edges 26 are separated by at least one opening or gap formed through faces 32, 34 so as to allow paint to pass between edges 26 of paddle portion 20. Because paint flows or passes through paddle portion 20 between edges 26 as paddle portion 20 is moved through paint, movement of paddle portion 20 through the paint encounters less resistance from the paint, allowing easier mixing. The opening or gap between edges 26 further enhances mixing of the paint by causing paint to fold. In the exemplary embodiment, edges 26 are separated by an opening or gap provided by four longitudinally spaced openings 36. Openings 36 are spaced apart from one another by intermediate bridges 38. Bridges 38 strengthen paddle portion 20 between edges 26 and between openings 36. As best shown by FIG. 6B, each of bridges 38 preferably has a thickness with an apex between adjacent openings 36 which tapers from the apex towards each opening 36. Because bridges 38 each have a thickness that smoothly tapers to each opening 36, faces 32 and 34 of paddle portion 20 each have a generally smooth continuous surface extending along axis 14. Consequently, faces 32, 34 of paddle portion 20 are easily wiped off and cleaned.

Although the openings between edges 26 are illustrated as being provided by a plurality of spaced oval openings 36, various alternative gaps or paint flow passages may be provided between edges 26. For example, alternatively shaped openings may be provided as well as greater or fewer openings may be provided. In one alternative embodiment, an elongate slit extending from tip 28 towards end 18 may be employed. This slit may have rigid internal edges or may alternatively include opposing fins of uniform thickness or tapering thickness, wherein the fins are flexible or elastomeric and spread apart as paddle portion 20 is moved through the paint to allow paint to pass between edges 26. In alternative embodiments, paddle portion 20 may be provided with transversely extending slits or openings, allowing paint to pass through paddle portion 20 between tip 28 and shoulders 30.

Tip 28 extends proximate to end 16 opposite shoulders 30. Tip 28 is preferably configured to mate or marry with the bottom interior contour of the paint container or can for which mixer 10 is to be employed. In particular, tip 28 is configured to project into the grooves or depressions formed within the interior floor of the paint container. In the exemplary embodiment, tip 28 is configured to mate with the interior floor of the paint container when one of edges 26 is positioned in engagement with the interior side surfaces or side walls of the paint container.

FIGS. 7, 7A and 7B depict mixer 10 positioned within a conventionally known paint can 12. As shown by FIG. 25, paint can 12 generally includes bottom 44, side 46, and upper rim 48. Side 46 is joined to bottom 44 and rim 48 along seams 50. Bottom 44 forms an internal floor 52 having a contour with an elevated portion 54. Due to this configuration of floor 52, tip 28 of paddle portion 20 includes central extension 56 and two opposite notches 58. As best shown by FIG. 26, central extension 56 is generally centered along axis 14 and is configured to mate with valley portion 53 of floor 52 while one of notches 58 receives elevated portion 54 of floor 52 and while one of edges 26 engages interior surface 60 of side wall 46. As a result, tip 28 of paddle portion 20 projects into the corners between valley portion 53 and elevated portion 54 as well as the corner between floor 52 and side wall 60 to scrape, lift and mix the thicker paint sediment which has settled in such corners. At the same time, edges 26 scrape, lift and mix the thicker paint sediments which have become deposited upon side wall 60 of paint container 12.

Although paint can 12 is a conventionally known paint can having a standard floor contour, paint container 12 may alternatively comprise other non-flat contours. In such instances, tip 28 may also have a reverse non-flat profile or contour so as to at least partially project into any grooves or depression in the floor portion. Furthermore, although tip 28 of paddle portion 20 is illustrated as having a pair of opposite notches 58 which enable either side of tip 28 to be positioned over elevated portion 54 of floor 52, tip 28 may alternatively have only a single notch 58 on one side. Tip 28 may also alternatively be configured so as to mate with a particular contour of floor 52 while not necessarily mating with or contacting side wall 60 of paint container 12.

Shoulders 30 extend opposite to tip 28 at a juncture of paddle portion 20 and neck portion 22. Each shoulder 30 generally extends in a transverse direction from neck portion 22 to edge 26. Each shoulder portion 30 has a transverse width W (shown in FIG. 7A) greater than or equal to the transverse width of rim 48. As a result, shoulders 30 permit edges 26 to be positioned against the interior side wall 60 of paint can 12 with edges 26 extending generally parallel to side wall 60. Although the mere inclusion of any shoulder permits edges 26 to reach beneath rim 48 to mix paint sediment located there, shoulders 30 preferably have a width sufficient so as to enable edges 26 to engage side walls 60. Although paddle portion 20 is illustrated as including the neck portion generally centered along the longitudinal center line 14 of mixer 10 such that shoulders 30 extend opposite one another and each have a substantially equal transverse width W (shown in FIG. 7A), mixer 10 may alternatively be configured such that paddle portion 20 has only a single shoulder or such that paddle portion 20 has two shoulders have unequal transverse widths W.

Faces 32, 34 extend opposite one another between edges 26. Faces 32, 34 provide the majority of the surface area which contacts the paint as paddle portion 20 is moved through the paint to mix the paint. Faces 32, 34, similar to the remainder of paddle portion 20, have an exterior surface that is liquid or moisture impermeable. As a result, faces 32 and 34 of paddle portion 20 do not absorb the paint being mixed, enabling paddle portion 20 to be more easily cleaned and reused. In the exemplary embodiment, paddle portion 20 is formed from a molded thermoplastic or thermoset material. In one exemplary embodiment, paddle portion 20 is formed from 100% polypropylene. Alternatively, paddle portion 20 may be formed from a mixture of plastic materials or multiple layers of different plastic materials. Additives, such as talc, may be added to improve material stiffness. In particular embodiments, paddle portion 20 may have a foamed core or a wooden core which is coated with a paint impervious material or materials.

As best shown by FIG. 6A, face 32 has a concave profile along axis 14 while face 34 has a convex profile or cross sectional shape along axis 14. As a result, when paddle portion 20 is moved through the paint in the direction of face 32, paint mixing and folding is enhanced. Alternatively, when paddle portion 20 is moved through the paint in the direction of face 34 with face 34 serving as a leading face, less resistance is encountered to ease stirring. The curvature of faces 32 and 34 further creates a vortex to enhance mixing. In the preferred embodiment, face 34 has a convexity or radius substantially similar to that of a conventional paint can internal rim radius such that face 34 substantially mated with the inner edge of the paint can rim to facilitate wiping of paint from face 34 into the paint can. In alternative embodiments, both faces 32 and 34 may either have a convex profile or a concave profile. In further alternative embodiments, one of faces 32, 34 may be flat while the other of faces 32, 34 may be provided with either a convex profile or a concave profile.

Neck portion 22 extends between paddle portion 20 and handle portion 24. Neck portion 22 has a reduced transverse width as compared to paddle portion 20 so as to form shoulders 30. Because neck portion 22 has a reduced transverse width relative to paddle portion 20 and handle portion 24, neck portion 22 enables paddle portion 20 to have a larger surface area for improved mixing and enables handle portion 24 to have an enlarged surface area for improved gripping while reducing overall resistance encountered by mixer 10 during the stirring of paint. Although less desirable, in alternative embodiments, neck portion 22 may be omitted.

Handle portion 24 is coupled to paddle portion 20 and preferably extends from neck portion 22 so as to provide a means for gripping or holding mixer 10 as paddle portion 20 is moved through the paint contained within paint container 12. Handle portion 24 is preferably configured so as to provide an ergonomic comfortable hand grip. Handle portion 24 is preferably configured so as to enable mixer 10 to be grasped using either a conductor wand grip or a fist grip. As best shown by FIG. 3, handle portion 24 generally includes ends 76, 78, edges 80, faces 82, 84 and hang hole 85. Ends 76 and 78 define the axial length of handle portion 24 from end 18 to neck portion 22. Faces 82 and 84 transversely extend between edges and generally provide gripping surfaces for handle portion 24. In the exemplary embodiment, face 82 has a concave profile along axis 14 while face 84 has a generally convex profile along axis 14. Face 82 preferably includes at least one thumb pod 86. Each thumb pod is preferably centered along axis 14 and includes a depression, ridge or a surface having a distinct texture or hardness so as to identify suggested gripping points for handle portion 24 and so as to further provide locations along handle portion 24 which are more slip resistant. In the embodiment illustrated, each of thumb pods 86 is illustrated as comprising a multitude of parallel ridges formed in a slight depression. Alternatively, thumb pods 86 may comprise an elevated or depressed layer of padding such as an elastic material like SANTOPRENE. This layer of padding may be smooth or may be additionally provided with ridges and the like. Although handle portion 24 is illustrated as including two such thumb pods, handle portion 24 may be provided with any number of thumb pods. Moreover, various additional or alternative locations of handle portion 24 may be provided with coatings or layers of elastomeric gripping material such as SANTOPRENE or with distinct ridges or surface textures for enhanced gripping.

As best shown by FIG. 5, face 84 includes a plurality of axially spaced finger locating depressions 88 (or alternatively a plurality of axially spaced fingers locating elevations 90). Depressions 88 generally extend transversely across face 84 and are sized to receive a person's fingers while the person's thumb is positioned on one of thumb pods 86. Such depressions 88 or elevations 90 may additionally be provided with distinct surface textures such as ridges, elastomeric padding layers and the like. Depressions 88 in combination with thumb pods 86 enable handle portion 24 to be gripped using a fist grip posture. Similarly, the arcuate contour of faces 82 and 84 facilitate handle portion 24 being gripped using a conductor wand posture. In alternative embodiments, handle portion 22 may have various other configurations enabling mixer 10 to be gripped. For example, although not illustrated, in one particular embodiment, handle portion 24 may alternatively include an end 78 which is configured to be coupled to a powered mixing device such as a powered rotational device like a drill or power paint mixer.

As shown by FIG. 5, handle portion 24 additionally includes a hanging hole which facilitates hanging of mixer 10 for display and/or storage.

FIG. 7 illustrates manually powered paint mixer 10 annotated to describe dimensions of one particular preferred embodiment. In the exemplary embodiment shown, mixer 10 has a length L1 from end 18 to shoulders 30 of approximately 7.25 inches. Length L2 from shoulders 30 to the end of tip 28 at end 16 is approximately 6.75 inches. Length L3 of each edge 26 which extends parallel to axis 14 is approximately 6.25 inches. Neck portion 22 has a length L4 of approximately 2 inches. Each opening 36 preferably comprises an isometric ellipse or oval having an isometric diameter of approximately 0.75 inches (measured through a 30° diagonal). Handle portion 24 has a concave guide with a radius of approximately 0.5 inches. Paddle portion 20 has a concave side with a radius of approximately 1.0 inches. The opposite convex sides or faces of handle portion 24 and paddle portion 20 have similar radiuses. Shoulders 30 each have a width W1 of approximately 0.40625 inches. Paddle portion 20 has a transverse width W2 of approximately 1.375 inches. Handle portion 24 has a width W3 of approximately 1.125 inches. For ease of gripping and use, all such edges are preferably rounded and smooth.

FIG. 8 illustrates mixer 110, an alternative embodiment of mixer 10. Mixer 110 (only of which portions are shown) is identical to mixer 10 except that mixer 110 includes handle portion 124 in lieu of handle portion 24. In contrast to handle portion 24, handle portion 124 is a rounded cylindrical handle having hang hole 85 and ribs 188. Hang hole 85 enables handle portion 124 and mixer 110 to be easily hung from a hook or other similar structure for display or storage. Ribs 188 are formed along the exterior surface of handle portion 124 and facilitate gripping of handle portion 124. In the exemplary embodiment, ribs 188 and the surrounding surface of handle portion 124 include a layer of at least one elastomeric material to provide a relatively soft compressible gripping surface. In the exemplary embodiment, this elastomeric material comprises a solvent resistant material such as SANTOPRENE sold by Advanced Elastomers. In the exemplary embodiment, this layer of elastomeric material is glued, fused, welded, riveted or otherwise coupled to an underlying rigid core which is integrally formed as part of neck portion 22 and paddle portion 20 of mixer 110.

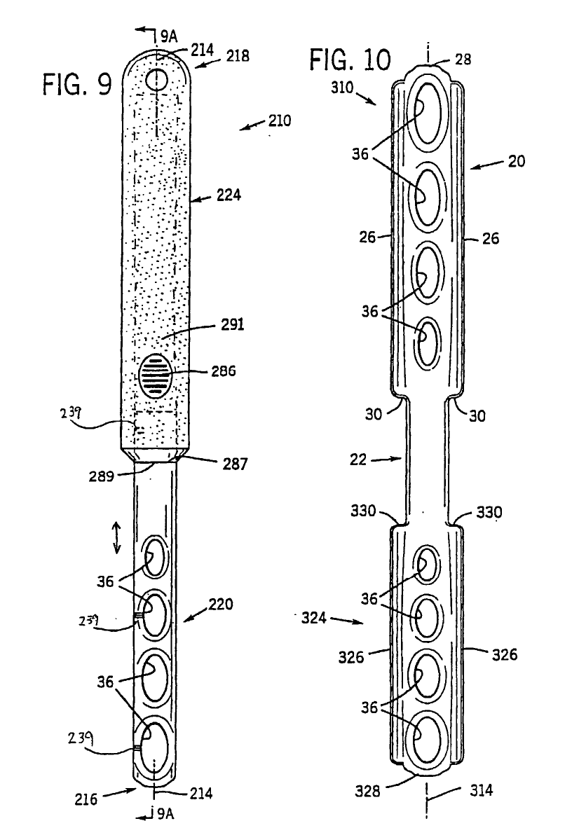

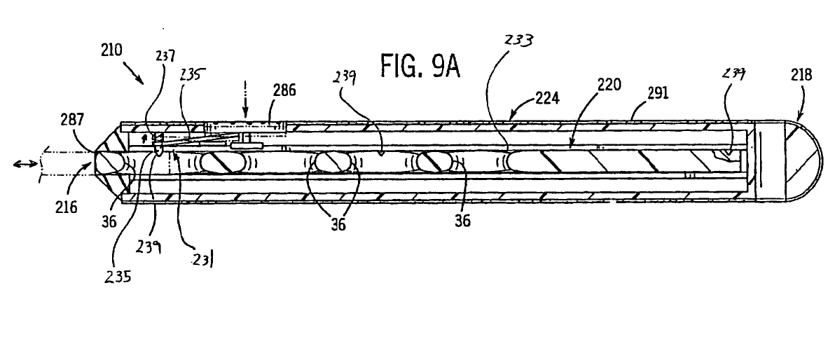

FIG. 9 and 9A illustrate manual paint mixer 210, a second alternative embodiment of mixer 10. Mixer 210 generally extends along axis 214 from end 216 to end 218. Mixer 210 generally includes paddle portion 220 and handle portion 224. Paddle portion 220 is movably coupled to handle portion 224 and is configured for being submersed in paint so as to mix paint as it is moved through the paint. Paddle portion 220 moves between an extended paint mixing position as shown in FIG. 9 and a retracted non-stirring position shown in FIG. 9A. In the retracted non-stirring position, at least a portion of paddle portion 220 and handle portion 224 are in overlapped positions such that the distance between ends 216 and 218 is reduced while paddle portion 220 is in the retracted position as compared to when paddle portion 220 is in the extended position. In the exemplary embodiment illustrated, paddle portion 220 is telescopically received within handle portion 224. In alternative embodiments, paddle portion 220 folds or pivots between the extended and retracted positions. Although paddle portion 220 is illustrated as being substantially identical to paddle portion 20 of mixer 10, paddle portion 220 may alternatively have a circular over cross sectional shape along axis 214 or may alternatively have a generally rectangular or flat cross sectional shape extending along axis 21 4. In particular embodiments, openings 36 may be omitted. Alternatively, paddle portion 220 may be provided with a single elongate slot extending from end 216 towards end 218.

Handle portion 224 provides a gripping surface for mixer 210. Handle portion 224 preferably includes a releasable locking mechanism 231 configured to releasably lock paddle portion 220 in either of the retracted position or the extended position. The selective locking mechanism 231 is preferably configured to releasably lock paddle portion 220 in a multitude of positions such that the desired length of paddle portion 220 may be selectively adjusted. In the embodiment illustrated in FIGS. 9 and 9A, handle portion 224 includes an internal cavity 233 sized to telescopically receive a majority, if not all, of the length of paddle portion 220. Locking mechanism 231 comprises a catch 235 resiliently biased towards paddle portion 220 by means of a spring 237. Actuation button 286 is in engagement with catch 235 and actuates catch 235 against the bias and away from handle portion 220 to enable slidable or telescopic adjustment of paddle portion 220 relative to handle portion 224. Catch 235 is configured to engage at least one of a plurality of longitudinally spaced detents 239 to enable paddle portion 220 to be retained at a plurality of lengths. In alternative embodiments, paddle portion 220 may be provided with a catch or projection while handle portion 224 is provided with a detent resiliently biased towards engagement with the projection or catch. In lieu of mechanism 231, mixer 210 may be provided with a variety of alternative selective locking mechanisms employing mechanical springs or resiliently flexible material which flexes the catch between an engaged and disengaged position.

In the particular embodiment in which handle portion 224 telescopically receives paddle portion 220, handle portion 224 includes at least one wiper surface 287 extending about a mouth 289 of handle portion 224. Wiper surface 287 is configured to serve as a seal against paddle portion 220 to prevent paint upon the surface of paddle portion 220 from entering the interior of handle portion 224 as paddle portion 220 is telescopically received by handle portion 224. In the exemplary embodiment, surface 287 is provided by an elastomeric gasket along mouth 289. This gasket is preferably hidden or at least partially hidden for aesthetic reasons. As a result, this gasket providing wiping surface 287 acts as an automatic cleaning shield. In alternative embodiments where paddle portion 220 pivots or folds relative to handle portion 224, similar wiping surfaces may be provided to wipe paint from paddle portion 220 as paddle portion 220 moves towards handle portion 224. In one alternative embodiment, handle portion 224 may be provided with an elongate slot extending along axis 214 such that paddle portion 220 pivots or folds into the elongate slot. As the paddle portion 220 is received within the elongate axial slot, wiping surfaces along the mouth of the slot remove paint from the surfaces of paddle portion 220. As shown in FIG. 9, handle portion 224 additionally includes a soft elastomeric outer surface 291 formed from material such as SANTOPRENE and an actuation button 286. In alternative embodiments, handle portion 224 may have various other gripping surfaces or structures as well as alternative configurations.

FIG. 10 illustrates manual paint mixer 310, a third alternative embodiment of paint mixer 10. Mixer 310 is similar to mixer 10 except that mixer 310 includes paddle portion 324 in lieu of handle portion 224. For ease of illustration, those remaining components of mixer 310 which correspond to mixer 10 are numbered similarly. Paddle portion 324 extends from neck portion 22 opposite paddle portion 20. Paddle portion 324 is substantially identical to paddle portion 20 except that paddle portion 324 has an axial length extending between shoulders 330 and tip 328 along axis 314 that is less than the axial length of paddle portion 20 extending between shoulders 30 and tip 28. In the particular embodiment illustrated in FIG. 10, paddle portion 20 has an axial length between shoulders 30 and tip 28 sufficiently large such that edges 26 may be placed in contact with a majority of the interior side wall 60 of a standard one-gallon paint can yet small enough such that shoulders 30 may be positioned below the rim 48 of a standard one-gallon paint can. In contrast, paddle portion 324 preferably has an axial length between shoulders 330 and tip 328 sufficiently large enough such that edges 326 may be placed in contact with the majority of the side surface wall 60 of a smaller paint can such as a quart paint can, yet small enough such that shoulders 330 may be positioned below rim 48 of a smaller paint can such as a quart paint can. Because mixer 310 includes a pair of differently sized paddle portions 20, mixer 310 can be utilized to mix paint in a variety of differently sized paint containers or paint cans. As will be appreciated, the larger and smaller paddle portions of mixer 310 may be re-dimensioned to allow mixing of paint in paint can size combinations other than a gallon and a quart.

When manual paint mixer 310 is being used to mix paint, one of paddle portions 20, 324 is submersed within the paint in the can while the other of paddle portions 20, 324 serves as a handle for manual paint mixer 310. In alternative embodiments, neck portion 22 may be additionally configured to serve as a handle extending between paddle portions 20 and 324. For example, neck portion 22 may be configured similar to handle portion 24. Although paddle portion 324 is illustrated as being substantially identical to paddle portion 20 except for its different axial length, paddle portion 324 may be configured differently than paddle portion 20. In yet another alternative embodiment, paddle portion 324 or neck portion 22 may be movably coupled to paddle portion 20 so as to permit paddle portion 324 to be moved between an extended paint mixing position and a retracted position and a retracted non-paint mixing position in which paddle portion 324 overlaps at least a portion of paddle portion 20 such that paint mixer 310 has a reduced axial length. For example, paddle portion 324 or neck portion 22 may be pivotally coupled to paddle portion 20, enabling paddle portion 324 to extend side by side or to be received sideways into the channel formed within paddle portion 20.

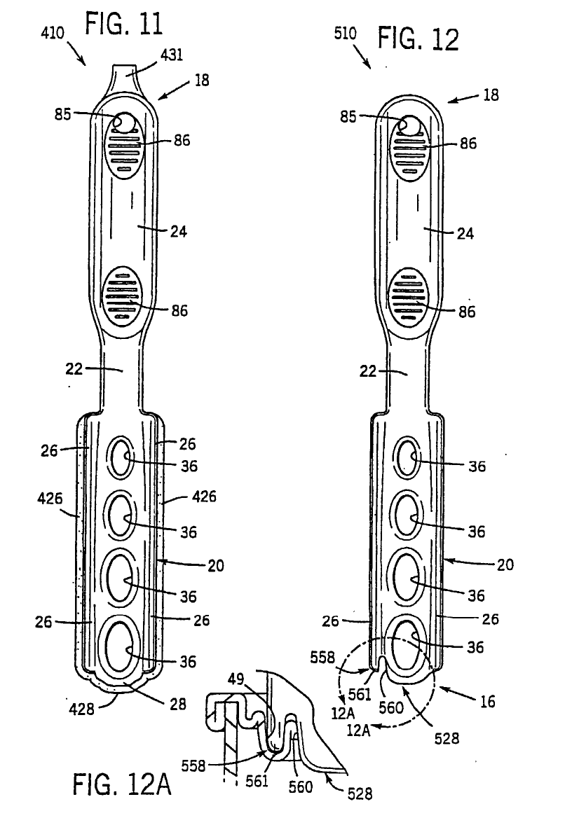

FIG. 11 illustrates manual paint mixer 410, a fourth alternative embodiment of manual paint mixer 10. Manual paint mixer 410 is substantially similar to manual paint mixer 10 except that manual paint mixer 410 additionally includes side wipes 426, tip wipe 428 and can opener 431. For ease of illustration, those remaining components of mixer 410 which are substantially similar to corresponding components of mixer 10 are numbered similarly. Side wipes 426 generally comprise elastomeric strips coupled to edges 26 of paddle portion 20. In the exemplary embodiment, side wipes 426 comprise strips of a solvent resistant material such as SANTOPRENE sold by Advanced Elastomers. Side wipes 426 provide flexible edges or blades which more closely conform to interior side surface 60 of paint container 12 to remove and mix paint sediment formed along side surface 60. In the particular embodiment illustrated, the elastomeric material forming side wipes 426 extends substantially only along edges 26. This material is preferably co-molded and fused to relatively rigid material forming the remainder of paddle portion 20. In alternative embodiments, the material may be applied over additional portions, including the entirety, of the remainder of paddle portion 20. Any of a variety of alternative elastomeric materials may also be used. Such elastomeric materials or flexible materials may be secured to the remainder of paddle portion 20 by various other methods.

Tip wipe 428 comprises a strip or blade of flexible or elastomeric material extending from tip 28 of paddle portion 20. Tip wipe 428 provides an adaptable or conformable edge or surface capable of more closely conforming to the floor 52 of container 12 to scrape and remove deposited paint settlement from the floor 52 for mixing. In the particular embodiment illustrated, tip wipe 428 comprises a solvent resistant material such as SANTOPRENE sold by Advanced Elastomers. The core material forming the remainder of mixer 410 is preferably polypropylene. SANTOPRENE is a polypropylene based thermoplastic elastomer (TPE) with vulcanized rubber dispersed in it. SANTOPRENE is solvent resistant. In particular, SANTOPRENE is sufficiently resistant to the following solvents so as to experience a weight change of less than 40 percent following ASTM test procedure D-471: 98% Sulfuric Acid; 10% Hydrochloric Acid; 50% Sodium Hydroxide; 10% Potassium Hydroxide; Water; Ethanol; n-Hexane; Methylethylketone; Acetone; Mineral Spirits; n-Octane; and n-Pentane.

Since both materials of the core and tip wipe 428 are polypropylene based, a better chemical and/or heat bond between both substrates exists than there would be with dissimilar materials. It will be understood that a bond may be formed by heat fusion or chemical reaction or both heat fusion and chemical reaction depending on the specific materials, times, temperatures and pressures utilized. Most preferably tip wipes 428 are secured to the core not only by the mechanical interlocks but also, to some degree, by a bond provided by heat and/or chemical means.

Other materials could be used for the core material, such as a polyethylene with the Santoprene TPE tip wipe 428. Both materials are in the polyolefin family and would bond and work, but probably not as well as the same material based components. Other base materials such as blends of polypropylene and polyethylene could also be used.

Still other material combinations could be used. For example, Krayton is a styrene based TPE which could be used. It would not be as effective as Santoprene since the base material is styrene which does not have nearly as good solvent resistance to paint solvents as does Santoprene It would be acceptable for latex or water based systems but not solvent based coatings. Polyvinylchloride (PVC) can also be used but like Krayton the PVC has limited resistance to non-water based solvents. A number of other core and tip wipe materials could be used to make mixer 410 but the materials described above both have a relatively high resistance to all paint solvents and a low manufacturing cost for a mixer.

The flexible material is preferably fused to the rigid material forming tip 28. Alternatively, the flexible material may be coupled to the remainder of paddle portion 20 by various other methods including adhesives, fasteners, mechanical interlocks, welds and the like. Although tip wipe 428 is illustrated as having a shape substantially identical to the shape of tip 28 of mixer 10, tip wipe 428 may alternatively have a lower edge shape which is flat, wherein the material itself changes shape when being flexed to conform to the floor of a particular paint can. Tip wipe 428 not only enables paint to be more easily removed from the floor of a paint container, tip wipe 428 also enables mixer 410 to remove paint sediment from the floor of a number of paint containers having differently configured or contoured floor surfaces. Tip wipe 428 is illustrated as being independently provided simultaneously with tip wipe 428. In particular embodiments, side wipes 426 as well as tip wipe 428 may be partially embedded or captured in grooves formed in the rigid portion of paddle portion 20. In yet alternative embodiments, the entirety of paddle portion 20 may be formed from one or more elastomeric materials, wherein the rigidity is controlled by the addition of core materials or additives to provide paddle portion 20 with sufficient rigidity to mix paint yet sufficient flexibility along one or more edge portions to adapt to varying internal paint can contours.

Can opener 431 comprises a rigid projection extending from handle portion 24. In the particular embodiment illustrated, can opener 431 comprises a metal tab projecting from end 18. Opener is configured to be received between the lid and rim 48 of a conventionally known paint can so as to enable opener to be pried against the lid to remove the lid from the paint can. Although can opener 431 is illustrated as extending from end 14, can opener 431 may alternatively extend from other portions of mixer 410. In the particular embodiment illustrated, can opener 431 comprises a metal tab integrally molded into handle portion 24. Alternatively, can opener 431 may be movably coupled to handle portion 24, enabling can opener 431 to move between an extended can opening position and a retracted position in which opener is received within or overlaps handle portion 24. For example, can opener 431 may be telescopically received within handle portion 24 or may pivot into a side channel or groove in handle portion 24. In such an alternative embodiment, handle portion 24 would additionally include a conventionally known or future developed locking mechanism for selectively and releasably locking can opener 431 in an extended position or a retracted position.

FIG. 12 illustrates manual paint mixer 510, a fifth alternative embodiment of paint mixer 10. Mixer 510 is substantially identical to mixer 410, except that mixer 510 includes tip 528 in lieu of tip 28. For ease of illustration, those remaining components of mixer 510 which correspond to similar components of mixer 10 are numbered similarly.

Tip 528 is similar to tip 28 except that tip 528 includes rim cleaner 558 in lieu of one of notches 58. Rim cleaner 558 includes an alternatively configured notch 560 providing tip 528 with a projection 561 configured to extend into the channel or groove 49 of rim 48 (shown in FIG. 12A). In the particular embodiment illustrated, projection 561 is preferably configured to project into groove 49 so as to mate with the floor and sides of groove 49 to wipe unwanted paint from groove 49. Projection 561 is further configured to direct the paint being wiped from channel 49 towards the opening of can 12. Although projection 561 is illustrated as being formed in the more rigid portion of paddle portion 20, the projection 561 forming rim cleaner 558 may alternatively be lined or coated with an elastomeric material to improve wiping capability. In one embodiment, projection 561 may be entirely formed from an elastomeric material. Moreover, in lieu of being formed or provided at end 1 6 of mixer 510, projection 561 of cleaner 558 may be provided along various other portions of mixer 510. For example, a projection similar to 561 may be provided along one of edges 26, along neck portion 22 or along handle portion 24. In still other embodiments, a projection or member configured to project into channel 49 and to clean rim 48 may be movably coupled to the remainder of mixer 510 so as to move between an extended cleaning position and a retracted non-cleaning position. This movement may either be telescopic or pivotal. Overall, rim cleaner 558 enables the rim of a paint can to be cleaned of paint which later solidifies to undesirably adhere the lid to the rim. Although rim cleaner 558 is illustrated as being employed on mixer 510, cleaner 558 may alternatively be utilized on the various other alternative embodiments of the manual paint mixers described herein.

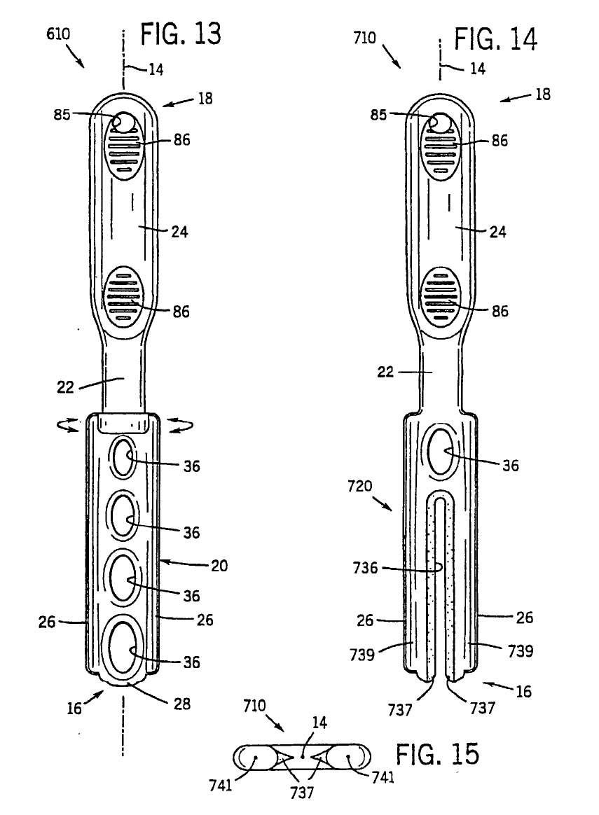

FIG. 13 illustrates manual paint mixer 610, a sixth alternative embodiment of paint mixer 10. Mixer 610 is substantially identical to mixer 10 except that paddle portion 20 is rotatably coupled to neck portion 22 for rotation about axis 14. For ease of illustration, those remaining components of mixer 610 which are substantially similar to mixer 10 are numbered similarly. Paddle portion 20 is rotatably coupled to neck portion 22 for rotation 360° about axis 14. The rotational movement of paddle portion 20 relative to neck portion 22 facilitates mixing of paint. In alternative embodiments, neck portion 22 and paddle portion 20 may be fixed relative to one another, wherein neck portion 22 rotates relative to handle portion 24 about axis 14. In other embodiments, at least paddle portion 20 rotates relative to handle portion 24 less than 360° in a fashion similar to a carrot or potato peeler. In such alternative embodiments, paddle portion 20 or the combination of paddle portion 20 and neck portion 22 have a limited rotational extent providing two opposing stop surfaces formed in one of the two adjacent surfaces which rotate relative to one another about axis 14 in mixer 610. In yet additional alternative embodiments, particular portions of paddle portion 20 rotate relative to other portions of paddle portion 20.

FIGS. 14 and 15 illustrate a manually powered paint mixer 710, a seventh alternative embodiment of mixer 10. Mixer 710 is similar to mixer 10 except that mixer 710 includes paddle portion 720 in lieu of paddle portion 20. For ease of illustration, those remaining components of mixer 710 which correspond to similar components of mixer 10 are numbered similarly. Paddle portion 720 is itself similar to paddle portion 20 except that paddle portion 720 includes a single opening 36 and further includes an elongate slit 736 in lieu of the remaining openings 36. Although paddle portion 720 is illustrated as having generally linear opposing faces, paddle portion 720 may alternatively include a concave face and an opposite convex face similar to paddle portion 20. Slit 736 forms an elongate opening extending from end 16 towards end 18. In lieu of the single opening 36, slit 736 may alternatively extend further towards end 18. Slit 736 is preferably sized so as to permit paint to flow between edges 26 so as to reduce the resistance encountered by paddle portion 720 when moved through the paint. At the same time, slit 736 is preferably sized such that the opposing faces of paddle 720 are sufficiently sized to adequately mix or stir the paint.

As further shown by FIGS. 14 and 15, slit 736 is preferably bordered by fins 737. Fins 737 comprise elongate blade-like strips of flexible material such as elastomeric material like SANTOPRENE. Fins 737 pivot relative to their adjacent prongs 739 away from the axial center 741 of prong 739 into slit 736. Preferably, the durometer of each fin 737 decreases as it approaches the axial center line 14 of mixer 710. In the particular embodiments illustrated, this is achieved by tapering each fin 737 as it approaches center line 14. Alternatively, this reduced rigidity (i.e., increased flexibility) may be achieved by appropriate selection of different materials having a different durometer or flexibility characteristics varying the amount or location of such materials. In the particular embodiment illustrated, each of prongs 739 is generally rigid and fins 737 are increasingly more flexible towards center line 14. Fins 737 are preferably formed from SANTOPRENE and are fused to prong 739. Alternatively, prongs 739 and fins 737 may be integrally formed or integrally co-molded as part of a single unitary body, wherein the materials or mixtures of materials chosen varies such that prongs 739 are more rigid as compared to fins 737. In alternative embodiments, fins 737 may be simply omitted to reduce manufacturing costs and flexibility.

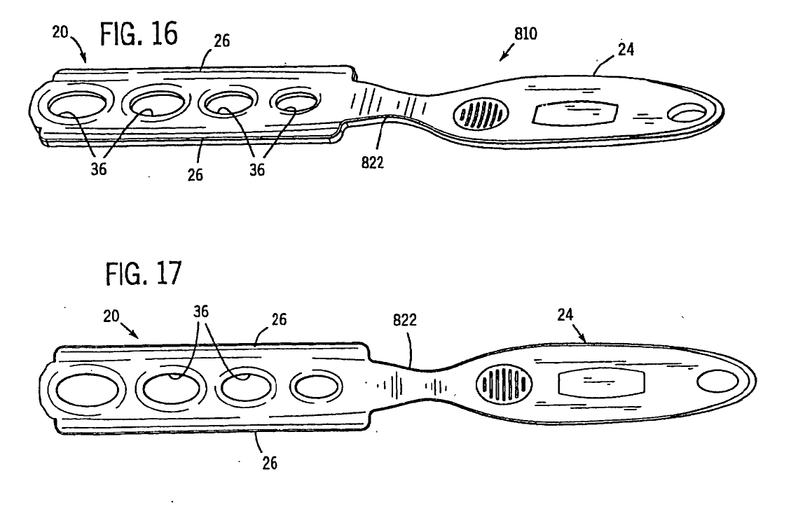

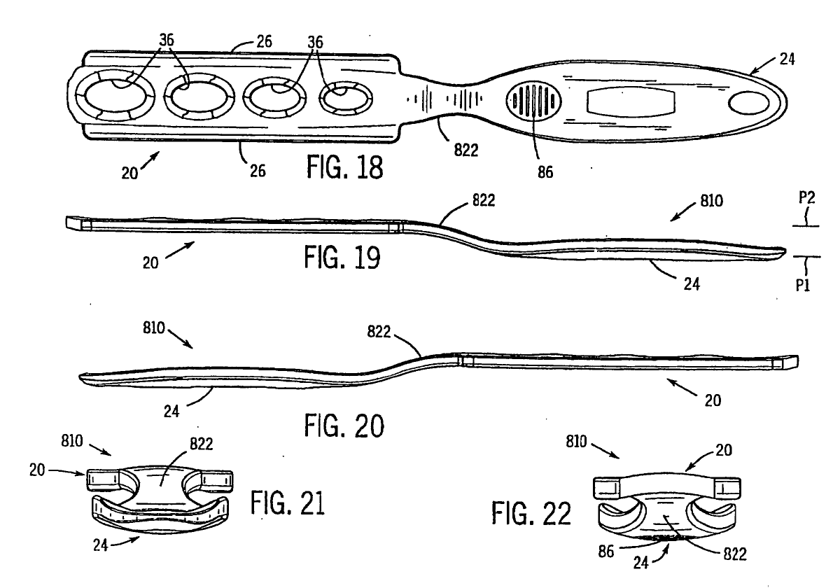

FIGS. 16-22 illustrate manual powered paint mixer 810, an alternative embodiment of mixer 10. Mixer 810 is similar to mixer 10, except that mixer 810 includes neck portion 822 in lieu of neck portion 22. For ease of illustration, those remaining components which correspond to similar components of mixer 10 are numbered similarly. As best shown by FIG. 19, neck 822 joins handle portion 24 and paddle portion 20 such that paddle portion 20 and handle portion 24 extend in generally offset planes P1 and P2. As a result, the overall strength of mixer 810 is increased. Although neck 822 is illustrated as gradually extending between planes P1 and P2 in a sloped fashion, neck 822 may be sloped downward at alternative angles or may step down. In the exemplary embodiment, planes P1 and P2 are spaced by a distance of approximately 0.4 inches. Neck 822 preferably has an axial length of approximately 1.2 inches.

As further shown by FIGS. 16-22, openings 36 have a reduced size as opening 36 approach handle portion 24. This sequential reduction in the size of opening 36 provides mixer 810 with an aesthetically attractive and unique appearance. Similarly, handle portion 24 has an oval contour similar to the shape of opening 36 to further provide mixer 810 with a symmetrical aesthetically attractive appearance.

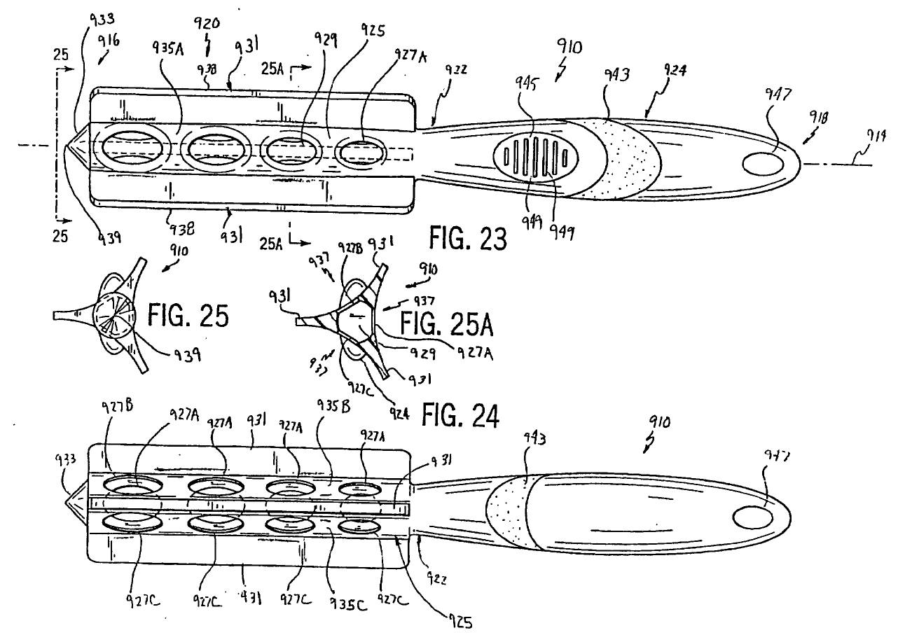

FIGS. 23-25A illustrate manual powered paint mixer 910, an alternative embodiment of mixer 10. Like mixer 10, mixer 910 is generally an elongate member extending along a longitudinal axis 914 from a first end 916 to a second end 918. Mixer 910 is generally an elongate stick configured for being manually manipulated to mix paint in a paint container or paint can. Mixer 910 may also be used for mixing other liquids or other dry materials. Mixer 910 generally includes paddle portion 920, neck portion 922, and handle portion 924. Paddle portion 920 is an elongate portion of mixer 910 configured to be submersed within the material and to store and mix the material as a result of movement of mixer 910. Paddle portion 920 includes hub 925, ports or openings 927A, 927B, 927C, flow passages 929 and blades 931. Hub 925 is coupled to handle portion 924 and extends from neck portion 922 towards end 916. Hub 925 forms openings 927 and flow passages 929 while supporting blades 931. In the exemplary embodiment, hub 925 includes 3 longitudinally extending sides 935A, 935B and 935C. Although hub 925 is preferably triangular in cross section, hub 925 may have various other shapes including a fewer or greater number of sides in cross section.

Openings 927A, 927B and 927C are located along sides 935A, 935B and 935C, respectively, of hub 925. Openings 927A, 927B, and 927C provide mouths through which fluid or dry material flows into and out of flow passage 929. In the exemplary embodiment, mixer 910 includes a plurality of longitudinally spaced openings 927A, 927B and 927C along sides 935A, 935B and 935C, respectively. Each opening 927A, 927B and 927C is sufficiently sized to permit the adequate flow of materials into flow passage 927 and out of flow passage 929. In the preferred embodiment illustrated, openings 927A, 927B, 927C are ovular in shape and are sized to permit the adequate flow of paint into and out of flow passage 927. Alternatively, such openings may have alternative sizes and configurations depending upon the desired aesthetic appearance as well as the type of material being mixed and its characteristics such as viscosity and the like. In the exemplary embodiment, each opening 927A, 927B, 927C comprises an isometric ellipse or oval having an isometric diameter of approximately 0.75 inches (measured through a 30° diagonal).

Flow passages 929 extend through hub 925 between openings 927A, 927B and 927C. As best shown by FIGS. 23 and 25A, each flow passage 929 is intersected by a flow separating structure provided by a portion of hub 925 and one of blades 931. In particular, material flow (such as a fluid or a dry granular material) entering flow passage 929 via one of openings 927 must divert or bend from its linear path so as to exit flow passage 929 through one of the other openings 927. This division or separation of flow through hub 925 of paddle portion 920 causes the material flow passing through mixer 910 to be turbulent, which causes the material to be more effectively mixed.

Blades 931 extend from hub 925 in directions away from one another. Blades 931 preferably comprise flat planar bands located between sides 935A, 935B and 935C. Blades 931 in conjunction with sides 935A, 935B and 935C, provide paddle portion 920 with three distinct faces 937 which face away from one another. Faces 937 are preferably angularly located approximately 120° relative to one another. Each face has an overall concave configuration so as to channel or direct material towards the openings located along, the face as paddle portion 920 is moved through the material being mixed.

Each of blades 931 includes an outer edge 938. Edges 938 preferably linearly extend along axis 914 so as to be capable of engaging and mating with interior side wall of a paint container or paint can. As a result, edges 938 enable mixer 910 to scrape accumulated sediment from the side walls of a paint container. Edges 938 are preferably integrally molded as part of the remainder of mixer 910 from the same rigid material (such as polypropylene) forming the remainder of blades 931. Alternatively, edges 938 may be provided with an outer surface of a soft, compressible elastomeric material, such as SANTOPRENE, or may be entirely formed from such a compressible material such as SANTOPRENE, rubber and the like to facilitate improved mating and wiping of sediment from the interior side walls of a paint container. In yet other alternative embodiments, each blade 931 may be formed entirely out of an elastomeric material.

Tip 933 projects from hub 925 at end 916. Tip 933 is configured to project into hard-to-reach corners, channels or grooves of a paint container or paint can where sediment or paint may accumulate. As best shown by FIG. 25, tip 933 preferably has a general conical shape terminating at a distinct point 939. Point 939 is configured such that it may be positioned within the corners of a paint can or in a rim of a paint can to mix sediment accumulated at such locations. Tip 933 preferably includes at least an outer surface formed from an elastomeric material, enabling tip 933 and point 939 to slightly flex or bend so as to better conform to the corners, rim or other hard to reach locations of a paint container or can. Although less desirable, other embodiments may include alternatively configured points in lieu of tip 933.

Handle portion 924 extends from paddle portion 920 and is joined to paddle portion 920 by neck portion 922. Handle portion 924 is configured to be easily grasped by a painter. Handle portion 924 generally includes band 943, thumb pod 945, and hang hole 947. Band 943 is formed from an elastomeric material and is co-molded and fused to the material forming the remainder of mixer 910. Alternatively, band 943 may be adhered or otherwise fastened to the exterior of handle portion 924. Band 943 provides a nonslip surface to facilitate gripping of handle portion 924. Band 943 may have a variety of shapes and configurations depending upon the desired aesthetic appearance.

Thumb pod 945 extends along an exterior surface of handle portion 924 and comprises a depressed area provided with ridges 949 facilitating gripping of handle portion 924. Although thumb pod 945 is illustrated as being formed from the same material as the majority of mixer 910, preferably polypropylene, thumb pod 945 may alternatively be provided with an outer layer of soft, compressible elastomeric material, such as SANTOPRENE, to facilitate improved slip resistance.

Hang hole 947 extends through handle portion 924 proximate end 918. Hang hole 947 is facilitated for enabling mixer 910 to be hung from peg, post, or other such device. As will be appreciated, hang hole 947 may alternatively comprise a hook or other means for hanging mixer 910.

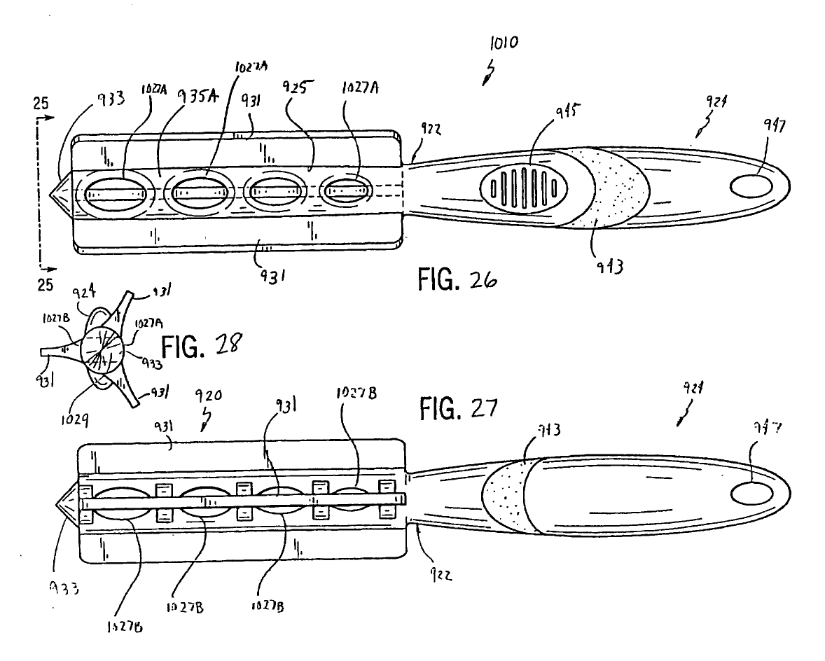

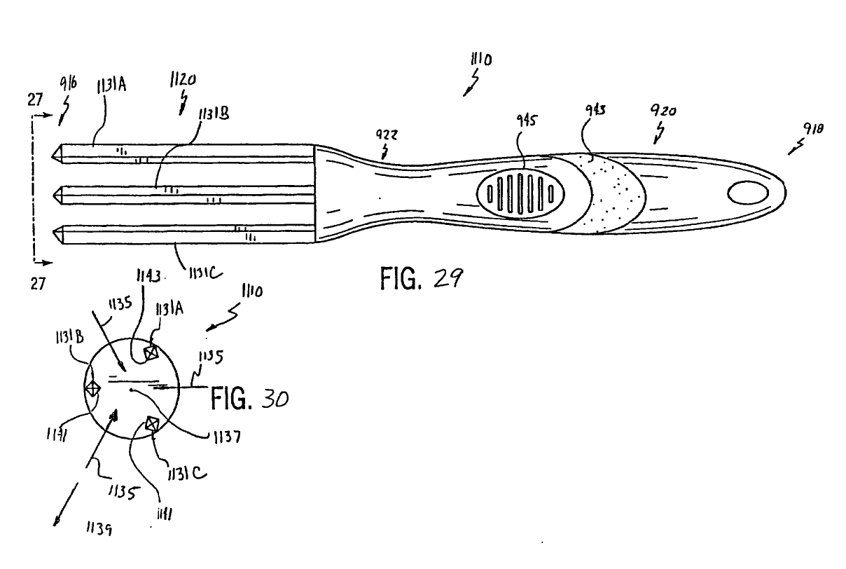

FIGS. 26-28 illustrate manual powered paint mixer 1010, an alternative embodiment of mixer 910. Mixer 1010 is similar to mixer 910 except that mixer 1010 includes openings 1027A, 1027B and flow passage 1029 in lieu of flow passages 927A, 927B, 927C, and flow passage 929. For ease of illustration, those remaining components of mixer 910 which correspond to similar components of mixer 910 are numbered similarly. Openings 1027A extend along side 935A of hub 925 and communicate with flow passages 1029. Openings 1027B are located opposite openings 1027A at longitudinally spaced positions between hub 925 and the blade 931, which extends perpendicular to and away from side 935A. Flow passages 1029 linearly extend and communicate with both of openings 1027A and 1027B. In use, blades 931 adjacent side 935A direct fluid or material into openings 1027A. The fluid or material within fluid passages 1029 thereafter splits or is divided upon reaching the opposite blade 931 which serves as a flow separator. As a result, dry material or fluid is more thoroughly and effectively mixed as paddle portion 920 of mixer 1010 is moved through the fluid or material.

FIGS. 29 and 30 illustrate manual powered paint mixer 1110, an alternative embodiment of mixer 910. Mixer 1110 is similar to mixer 910 except that mixer 1110 includes paddle portion 1120 in lieu of paddle portion 920. Paddle portion 1120 extends from neck portion 922 and handle portion 924 towards end 916. Paddle portion 1120 generally includes prongs 1131A, 1131B, 1131C. Prongs 1131A, 1131B, 1131C project from neck portion 922 and are spaced apart from one another so as to form flow passages between consecutive prongs 1131A, 1131B, 1131C. In particular, depending upon the direction in which mixer 1110 is moved through a fluid or material, the fluid or material may initially flow between any two adjacent prongs 1131A, 1131B, 1131C along one of the flow passages indicated by arrows 1135 towards longitudinally extending center line 1137. As best shown by FIG. 30, in addition to providing consecutive surfaces which direct the material towards center point 1137, prongs 1131A, 1131B, 1131C also provide a flow separating structure located in relationship to a flow passage so as to divide material flowing through the flow passage. For example, when mixer 1110 is moved through a material in the direction indicated by arrow 1139, material flows along flow passage 1135 between prongs 1131B and 1131C. The material thereafter encounters prong 1131A which separates the material and causes the material to bend and flow between prongs 1131B and 1131A, and prongs 1131C and 1131A.

In the exemplary embodiment, each prong 1131A, 1131B and 1131C is diamond-shaped in cross section and is oriented so as to include sides 1141 which are angled so as to channel fluid towards center point 1137, and points 1143 which are pointed at center line 1137 so as to intersect center line 1137 and precisely split the fluid flow into two portions.

Although less desirable, prongs 1131A, 1131B and 1131C may have other shapes and configurations. For example, such alternative prongs may have circular, oval, triangular or rectangular cross sectional shapes. Moreover, the size and spacing of prongs 1131A, 1131B and 1131C may be varied depending upon the characteristics of the material being mixed and the acceptable resistance encountered by the user while moving mixer 1110 through the material. For example, each of prongs 1131A, 1131B and 1131C may be enlarged or may be more closely positioned to one another. Although prongs 1131A, 1131B and 1131C are illustrated as having the same general size and configuration, the shape and configuration of each prong may be varied relative to the other prongs. Furthermore, although mixer 1110 is illustrated as preferably including three prongs angularly spaced approximately 120° from one another about center point 1137, mixer 1110 may alternatively include a greater number of prongs at alternative angular spacings. Although mixer 1110 is illustrated as preferably including a plurality of prongs 1131 A, 1131B and 1131C that linearly extend from handle portion 924, mixer 1110 may less desirably include a single prong which is formed from a sufficiently rigid, inflexible material (such as polypropylene) so to maintain its configuration as mixer 1110 is moved through paint and which is angled or helical so as to simultaneously provide an at least partially vertical (or horizontal) flow channel and to provide at least one flow separating structure dividing flow through the channel.

FIGS. 31-36 illustrate manually powered paint mixer 1210, a twelfth alternative embodiment of mixer 10. Mixer 1210 generally extends along axis 1214 from end 1216 to end 1218 and generally includes paddle portion 1220 and handle portion 1224. Paddle portion 1220 is coupled to handle portion 1224 and is configured to be submersed in paint so as to mix paint as it moves through paint. Paddle portion 1220 generally includes edges 1226, tip 1228, shoulders 1230, and opposing faces 1232, 1234. Edges 1226 extend on opposite transverse sides of paddle portion 1220 between faces 1232, 1234. Edges 1226 taper or converge to wards one another to wards tip 1228 on end 1218. Edges 1226 are configured to bear against the interior side surfaces of a paint container or paint can so as to wipe paint sediment away from the interior sides of the can for mixing. Because edges 1226 taper, edges 1226 may be placed against the interior sides of the paint container while the handle portion 1224 extends towards and over the central opening of the paint container to facilitate easier gripping of paddle portion 1224 and to further facilitate easier movement of mixer 1220 while mixer 1210 is partially within the paint container. In the particular embodiment illustrated, edges 1226 taper at an angle A of at least about 1.0 inch and nominally 5 degrees. As further shown by FIGS. 31-33, edges 1226 are separated by at least one opening or gap 1236 similar to opening 36 of mixer 10.

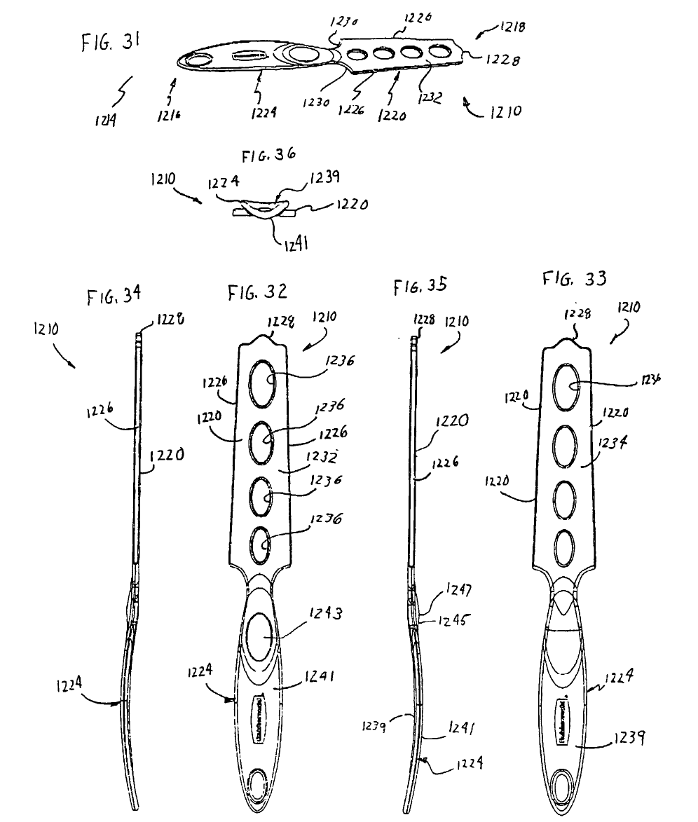

Handle portion 1224 extends from paddle portion 1220 so as to provide a means for gripping or holding mixer 1210 as paddle portion 1220 moves through the paint contained within the paint container. Handle portion 1224 is preferably configured so as to provide an ergonomic comfortable hand grip. As best shown by FIGS. 34 and 35, handle portion 1224 extends in an arcuate plane so as to have a concave face 1239 facing the same direction as face 1234 and so as to have a concave face 1241 facing the same direction as face 1232 of paddle portion 1220. Faces 1239 and 1231 preferably have a radius of approximately 3.4 degrees. Because faces 1239 and 1241 of handle portion 1224 are arcuate, handle portion 1224 is easier to grip while paddle portion 1220 moves through the paint.

To further facilitate improved gripping, handle portion 1224 additionally includes hand grip 1243. Hand grip 1243 provides a surface against which the painter may place his or her thumb while gripping handle portion 1224. Thumb grip 1243 preferably constitutes a slight depression or recess 1245 at least partially bounded by a frontward most ridge 1247. Depression 1245 and ridge 1247 cooperate to retain the user's thumb in place and to prevent the painter's hand from flipping towards the paddle portion 1220 by mixing paint. According to one preferred embodiment, thumb grip 1243 includes an exterior surface formed from a compressible soft material such as an elastomeric material. Although less desirable, thumb grip 1243 may be formed from a rigid polymeric material or other rigid material.

As shown by FIG. 36, faces 1239 and 1241 are further arcuate along axis 1214. In particular, face 1239 is concave along axis 1214 while face 1241 is convex along axis 1214. As a result, face 1241 conforms to the painter's curled fingers while face 1239 receives the painter's thumb and guides the positioning of the painter's thumb upon thumb grip 1243. Alternatively, faces 1239 and 1241 enable mixer 1210 to be grasped using a fifth grip style.

Mixer 1210 is preferably formed from a single integral unitary body of a rigid polymeric material such as polypropylene. Alternatively, other polymeric materials, wood or metal materials, may be used. Moreover, mixer 1210 may be formed from a mix of different materials, layers of different materials or from separate components welded, adhered or otherwise fastened together.

Manual powered paint mixers 10, 110, 210, 310, 410, 510, 610, 710, 810, 910, 1010, 1110 and 1210 illustrate various embodiment employing combinations of different features that enable the mixers to more effectively separate paint sediment from interior surfaces of the can, that more effectively mix the sediment with the remaining paint, that are easy to clean and less messy to use and that are less fatiguing to hold and mix the paint. Although manual paint mixers 10, 110, 210, 310, 410, 510, 610, 710, 810, 910, 1010, 1110 and 1210 are preferred embodiments of such manual paint mixers, various other paint mixers having individual features or alternative combination of features are contemplated.

Although the present invention has been described with reference to preferred embodiments, workers skilled in the art will recognize that changes may be made in form and detail without departing from the spirit and scope of the invention. For example, although different preferred embodiments may have been described as including one or more features providing one or more benefits, it is contemplated that the described features may be interchanged with one another or alternatively be combined with one another in the described preferred embodiments or in other alternative embodiments. Because the technology of the present invention is relatively complex, not all changes in the technology are foreseeable. The present invention described with reference to the preferred embodiments is manifestly intended to be as broad as possible. For example, unless specifically otherwise noted, the claims reciting a single particular element also encompass a plurality of such particular elements.

What is claimed is:

1. A manual mixing apparatus for use with a paint container having an interior floor, a rim having a width and an interior height between the floor and the rim, the apparatus comprising:
an elongate member extending along a longitudinal axis from a first end to a second end, the member including:
a first paddle portion proximate the first end, the first paddle portion including a first face, a second face, a first edge, a second edge and at least one opening between the first edge and the second edge, wherein the first face is concave so as to direct fluid towards the at least one opening.

2. The apparatus of claim 1 including a plurality of openings, wherein consecutive openings are spaced by a bridge and wherein the bridge has an apex and tapers from the apex towards adjacent openings.

3. The apparatus of claim 1 including a handle portion coupled to the first paddle portion.

4. The apparatus of claim 3 wherein the handle portion includes an elastomeric gripping surface.

5. The apparatus of claim 3 wherein the first paddle portion moves between a first position in which the handle portion receives at least part of the first paddle portion and a second position in which said at least part of the first paddle portion projects from the handle portion.

6. The apparatus of claim 5 wherein the handle portion includes at least one wiper configured to wipe paint from the first paddle portion as a first paddle portion moves towards the first position.

7. The apparatus of claim 3 wherein the first paddle portion moves between a retracted position in which the handle portion and at least a part of the first paddle portion are overlapping and an extended position.

8. The apparatus of claim 5 wherein the handle portion telescopically receives said at least part of the first paddle portion.

9. The apparatus of claim 8 wherein the handle portion includes at least one wiper configured to wipe said at least part of the first paddle portion as the first paddle portion telescopically moves into the handle portion.

10. The apparatus of claim 3 wherein the first paddle portion moves between the paint stirring position and a retracted position.

11. The apparatus of claim 3 wherein the handle portion includes a plurality of finger grooves.

12. The apparatus of claim 3 wherein the handle portion includes at least one thumb pod.

13. The apparatus of claim 3 wherein the handle is configured to provide an ergonomic fit for user's hand.

14. The apparatus of claim 13 wherein the handle portion is configured to be gripped by a hand in either a conductor wand posture or a fist gripped posture.

15. The apparatus of claim 3 wherein the handle portion has an arcuate cross sectional shape.

16. The apparatus of claim 15 wherein the neck portion and the paddle portion are joined along first and second opposite shoulders and wherein the first and second opposite shoulders each has a width not less than the width of the rim of the paint container.

17. The apparatus of claim 24 wherein the interior floor includes at least one convolution, wherein the paddle portion has a first tip at the first end, and wherein the first tip is configured to substantially mate with the at least one convolution of the paint container.

18. The apparatus of claim 1 including a neck portion adjacent the first passage portion and a second paddle portion extending from the neck opposite the first paddle portion.

19. The apparatus of claim 18 wherein the neck portion and the second paddle portion are joined along at least one shoulder and wherein the at least one shoulder has a width greater than the width of the rim of the paint container.

20. The apparatus of claim 18 wherein the first paddle portion has a first axial length and wherein the second paddle portion has a second axial length different than the first axial length.

21. The apparatus of claim 33 wherein the second paddle portion has a second tip at the second end, wherein the second tip is configured to substantially mate with the floor contour of the paint container.

22. The apparatus of claim 18 wherein the second paddle portion has a second tip at the second end and wherein the second tip is configured to substantially mate with a floor contour of the paint container.

23. The apparatus of claim 1 including:
a second paddle portion opposite the first paddle; and
a handle portion joining the first paddle portion and the second paddle portion.

24. The apparatus of claim 2 wherein at least one of the first edge and the second edge includes an elastomer.

25. The apparatus of claim 1 wherein the first paddle portion has a tip and wherein the tip includes at least one elastomer.

26. The apparatus of claim 1 wherein the rim of the paint container has a groove for receiving a lid and wherein the apparatus includes a projection configured to project into the groove.

27. The apparatus of claim 1 wherein the paint container has a lid sealingly coupled to the rim and wherein the apparatus includes a projection configured to be received between the lid and the rim to separate the lid from the rim.

28. The apparatus of claim 27 wherein the apparatus is formed from a polymeric material and wherein the projection is coupled to the polymeric material and is formed from a metallic material.

29. The apparatus of claim 1 wherein the elongate member rotatably supports the first paddle portion.

30. The apparatus of claim 29 wherein the first paddle portion is supported for rotation of 360°.

31. The apparatus of claim 1 wherein the apparatus is configured to be removably mounted to a rotary spinning device.

32. The apparatus of claim 1 wherein the first paddle portion is formed from a volume of material so as to be sufficiently rigid to withstand bending forces encountered during movement of the first paddle portion through a conventional interior paint fluid during mixing of the paint fluid.

33. The apparatus of claim 32 wherein the first paddle portion is formed from a polymeric material.

34. The apparatus of claim 32 wherein the first paddle portion is formed from a polypropylene material having a talc additive.

35. The apparatus of claim 1 wherein the second face is concave so as to direct fluid towards the at least one opening.

36. The apparatus of claim 1 wherein the first paddle portion includes a third face extending along the first face and the second face.

37. The apparatus of claim 36 wherein the third face is concave so as to direct fluid towards the at least one opening.

38. The apparatus of claim 36 wherein the at least one opening extends through the first face, the second face and the third face.

39. The apparatus of claim 36 wherein the first face, the second face and the third face face away from one another.

40. The apparatus of claim 39 wherein the first face, the second face and the third face face in a first direction, a second direction and a third direction, respectively, and wherein the first direction, the second direction and the third direction are angularly spaced from one another by about 120 degrees.

41. The apparatus of claim 39 wherein the first face, the second face and the third face face in first, second and third directions, respectively, which are equiangularly spaced from one another.

42. The apparatus of claim 1 wherein the first paddle portion includes at least one blade at least one blade at least partially spanning the at least one opening.

43. The apparatus of claim 42 wherein the at least one blade extends along the longitudinal axis.

44. The apparatus of claim 43 wherein the at least one blade extends parallel to the longitudinal axis.

45. The apparatus of claim 1 including a cone-shaped tip at the first end.

46. The apparatus of claim 45 wherein the cone-shaped tip includes an elastomeric material.

47. The apparatus of claim 41 wherein the first end terminates at a point.

48. A manual mixing apparatus comprising:
an elongate member extending along a longitudinal axis from a first end to a second end, the member including a first surface and a second surface separated by a first flow passage therebetween; and
a first flow separating structure located in relationship to the first flow passage such that the material flowing through the first flow passage is divided by the first flow separation structure.

49. The apparatus of claim 48 wherein the first flow separating structure comprises a blade.

50. The apparatus of claim 48 wherein the first paddle portion includes at least one continuously mounted opening supported by the first surface and the second surface and forming the first flow passage.

51. The apparatus of claim 50 wherein the first flow separating structure spans the at least one opening.

52. The apparatus of claim 50 wherein the first flow separating structure extends between opposite sides of the at least one opening.

53. The structure of claim 50 wherein the at least one opening has a center point and wherein the first flow separating structure extends in a plane containing the center point.

54. The apparatus of claim 48 wherein the first flow separating structure is integrally formed as part of a single unitary body with the first paddle portion.

55. The apparatus of claim 48 wherein the first paddle portion includes at least three outwardly facing faces and wherein the first opening extends through the at least three faces.

56. The apparatus of claim 55 wherein the at least three faces includes a first face and wherein the first face is concave.

57. The apparatus of claim 56 wherein the first face is concave along the longitudinal axis.

58. The apparatus of claim 48 including a third surface separated from the first surface by a second flow passage therebetween and wherein the apparatus further includes a second flow separating structure located so as to divide fluid flowing through the second flow passage.

59. The apparatus of claim 48 including a third surface spaced from the first surface by a second flow passage.

60. The apparatus of claim 59 wherein the first paddle portion continuously surrounds the first flow passage and the second flow passage.

61. The apparatus of claim 60 wherein the first flow passage and the second flow passage are longitudinally spaced from one another.

62. A manual paint mixing apparatus comprising:
an elongate member extending along a longitudinal axis from a first end to a second end, the member including:
a first paddle portion proximate the first end; and
a conical surface coupled to the first paddle portion at the first end.

63. The apparatus of claim 62 wherein the conical surface includes at least one elastomeric material.

64. The apparatus of claim 62 wherein the first paddle portion includes at least one flow passage extending through the first paddle portion.

65. The apparatus of claim 64 including at least one flow separating structure located so as to divide fluid flow passing through the at least one flow passage.

66. The apparatus of claim 64 wherein the at least one flow passage includes at least one continuously bounded opening.

67. A manual painting mixing apparatus comprising:
an elongate member extending along a longitudinal axis from a first end to a second end, the member including a first paddle portion proximate the first end, the first paddle portion including a first edge, a second edge, and at least one first opening between the first edge and the second edge; and
a second paddle portion proximate the second end, the second paddle portion including a third edge, a fourth edge and at least one second opening between the third edge and the fourth edge.

68. A manual painting mixing apparatus comprising:
an elongate member extending along a longitudinal axis from a first end to a second end, the member including:
a handle portion; and
a paddle portion coupled to the handle portion, the paddle portion including a first edge, a second edge and at least one opening between the first edge and the second edge, wherein the paddle portion moves between a retracted position in which the handle portion and at least a part of the paddle portion are overlapping and an extended position.

69. A manual paint mixing apparatus comprising:
an elongate member extending along a longitudinal axis from a first end to a second end, the member including:
a paddle portion proximate the first end, the paddle portion including a first face, a second face, a first edge, a second edge, and at least one opening between the first edge and the second edge, wherein at least one of the first end, the first edge and the second edge include an elastomeric wiping surface.

70. A manual paint mixing apparatus for use with a paint container having a rim including a channel, the apparatus comprising:
an elongate member extending along a longitudinal axis from a first end to a second end, the member including a handle portion; and
a tip portion coupled to the handle portion, the tip portion being configured to substantially project into the channel of the paint container rim to remove paint from the channel.

71. A manual paint mixing apparatus comprising:
an elongate member extending along a longitudinal axis from a first end to a second end, the member including:
a handle portion; and
a paddle portion rotatably coupled to the handle portion, wherein the paddle portion at least partially rotates relative to the handle portion during mixing of paint.

72. A manual paint mixing apparatus comprising:
an elongate member extending along a longitudinal axis to a first end to a second end, the member including:
a paddle portion proximate the first end, the paddle portion including a first face, a second face, a first edge, a second edge, and at least one opening between the first edge and the second edge, wherein the first edge and the second edge taper towards the first end.

73. The apparatus of claim 72 wherein the elongate member includes a handle coupled to the paddle portion at a neck and wherein the first edge and the second edge taper from a location substantially proximate the neck towards the first end.
